(19) United States
(12) Patent Application Publication
(10) Pub. No.: US 2026/0350873 A1
(43) Pub. Date: Nov. 5, 2026

(54) Accessibility UI for User Color Vision Deficiencies

(71) Applicant: Xerox Corporation, Norwalk, CT (US)

(72) Inventors: Rajana M. Panchani, London (GB); Michael John Wilsher, Herts (GB); Martyn Williams, South Glamorgan (GB); Paul Joslyn, Oxfordshire (GB); Clara Cuciurean-zapan, Fairport, NY (US)

(21) Appl. No.: 19/194,231

(22) Filed: Apr. 30, 2025

(51) Int. Cl. G06T 11/60; G06T 11/10

(52) U.S. Cl. CPC G06T 11/60; G06T 11/10; G06T 2200/24

(57) ABSTRACT

Methods and systems are disclosed for displaying elements on a graphical user interface for users with a color-vision deficiency. A method includes receiving an indication of a type of CVD of a user. The method further includes receiving information associated with an element to display on a graphical user interface. The method further includes receiving a desired level of correction from the user. The method further includes applying the desired level of correction to the element to display by (a) determining an uncorrected representation of the element, (b) determining a fully corrected representation of the element, and (c) producing a blended representation based on the uncorrected representation, the fully corrected representation, and the desired level of correction. The method further includes displaying the blended representation on the graphical user interface.

### BACKGROUND

Color blindness or color vision deficiency (CVD) is the decreased ability to see color or differences between colors. The severity of color blindness ranges from mostly unnoticeable to full absence of color perception. Color blindness is usually an inherited problem or variation in the functionality of one or more of the three classes of cone cells in the retina, which mediate color vision. In humans, cones are normally one of three types: S-cones, M-cones and L-cones, which are sensitive to visible wavelengths of light that correspond to short-wavelength, medium-wavelength, and longer-wavelength light, respectively. The most common form of CVD is caused by a genetic condition called congenital red-green color blindness (including protan and deutan types) which affects up to 1 in 12 males (8%) and 1 in 200 females (0.5%).

Diagnosis of color blindness is usually done with a color vision test, such as the Ishihara test. The Ishihara test includes patterns of dots which form a number or shape that may be difficult to discern by those with a particular type of CVD.

Difficulty discerning differences in color can lead to poor accessibility outcomes when users interact with a color graphical user interface, e.g., that may appear on a display device of a computer, smartphone, or a user interface of an electronic device, such as a printer or a vehicle dashboard display. Furthermore, the degree of difficulty may vary with the type of CVD. However, overcorrecting a user interface to address a CVD may result in loss of information, also leading to poor outcomes.

This document describes improvements that address at least some of the issues described above.

### SUMMARY

The present disclosure describes embodiments related to displaying elements on a graphical user interface in an accessible manner for users with a CVD. A computer device includes a display, a processor, a computer readable memory, a computer readable storage medium, and program instructions stored on the computer readable storage medium for execution by the processor. The program instructions are configured to cause the computer device to (a) receive an indication of a type of color-vision deficiency of a user, (b) receive information associated with an element to display on a graphical user interface, and (c) receive a desired level of correction from the user. The program instructions are configured to cause the computer device to apply the desired level of correction to the element to display by (a) determining an uncorrected representation of the element based on the information associated with the element to display and (b) determining a fully corrected representation of the element based on the information associated with the element to display and the indication of the type of color-vision deficiency, and (c) producing a blended representation based on the uncorrected representation, the fully corrected representation, and the desired level of correction. The program instructions are further configured to cause the computer device to display the blended representation on the graphical user interface.

Implementations of the disclosure may include one or more of the following optional features. In some examples the program instructions that are configured to cause the computer device to apply the desired level of correction by producing a blended representation include program instructions that are configured to cause the computer device to apply the desired level of correction by performing a weighted average of one or more values associated with pixels of the uncorrected representation and corresponding values associated with pixels of the fully corrected representation, based on the desired level of correction, to produce pixels of the blended representation. The program instructions that are configured to cause the computer device to display the blended representation may include program instructions that are configured to cause the computer device to display pixels of the blended representation. In some examples, the program instructions that are configured to cause the computer device to receive information associated with the element to display include program instructions that are configured to cause the computer device to receive information associated with an icon to display on the graphical user interface; and the program instructions that are configured to cause the computer device to display the blended representation include program instructions that are configured to cause the computer device to display a blended representation of the icon on the graphical user interface.

In some examples, the program instructions that are configured to cause the computer device to receive information associated with the element to display include program instructions that are configured to cause the computer device to receive information associated with a window to display on the graphical user interface; and the program instructions that are configured to cause the computer device to display the blended representation include program instructions that are configured to cause the computer device to display a blended representation of the window on the graphical user interface. In some examples, the program instructions are further configured to cause the computer device to (a) associate the indication of the type of color-vision deficiency and the desired level of correction with an account associated with the user and (b) automatically apply the desired level of correction to subsequent elements to display. The program instructions that are configured to cause the computer device to receive the desired level of correction from the user may include program instructions that are configured to iteratively receive the desired level of correction and display the blended representation until the user is satisfied with the blended representation.

In some examples, the program instructions are further configured to cause the computer device to (a) receive an uncorrected representation of an image, (b) determine a fully corrected representation of the image based on the uncorrected representation of the image and the indication of the type of color-vision deficiency, and produce a blended representation of the image based on the uncorrected representation, the fully corrected representation, and the desired level of correction. In some examples, (a) the program instructions that are configured to cause the computer device to receive the uncorrected representation of the image include program instructions that are configured to cause the computer device to receive the image from a camera or an image scanner and (b) the program instructions are further configured to cause the computer device to store the blended representation of the image in a computer file. In some examples, (a) the program instructions that are configured to cause the computer device to determine the fully corrected representation include program instructions that are configured to cause the computer device to apply a transform to the fully corrected representation and (b) the program instructions that are configured to cause the computer device to apply the desired level of correction by producing a blended representation include program instructions that are configured to cause the computer device to apply the desired level of correction by (i) adjusting the transform based on the desired level of correction to produce an adjusted transform and (ii) applying the adjusted transform to the uncorrected representation of the element.

In another aspect, a method of displaying elements on a graphical user interface includes, by a processor, (a) receiving an indication of a type of color-vision deficiency of a user, (b) receiving information associated with an element to display on a graphical user interface, and (c) receiving a desired level of correction from the user. The method may further include applying the desired level of correction to the element to display by (a) determining an uncorrected representation of the element based on the information associated with the element to display, (b) determining a fully corrected representation of the element based on the information associated with the element to display and the indication of the type of color-vision deficiency, and (c) producing a blended representation based on the uncorrected representation, the fully corrected representation, and the desired level of correction; and displaying the blended representation on the graphical user interface.

Implementations of the disclosure may include one or more of the following optional features. In some examples, producing a blended representation includes performing a weighted average of one or more values associated with pixels of the uncorrected representation and corresponding values associated with pixels of the fully corrected representation, based on the desired level of correction, to produce pixels of the blended representation. Displaying the blended representation may include displaying pixels of the blended representation. In some examples, (a) receiving information associated with the element to display includes receiving information associated with an icon to display on the graphical user interface and (b) displaying the blended representation includes displaying a blended representation of the icon on the graphical user interface. In some examples, (a) receiving information associated with the element to display includes receiving information associated with a window to display on the graphical user interface and (b) displaying the blended representation includes displaying a blended representation of the window on the graphical user interface.

The method may further include (a) associating the indication of the type of color-vision deficiency and the desired level of correction with an account associated with the user and (b) automatically applying the desired level of correction to subsequent elements to display. Receiving the desired level of correction from the user may include iteratively receiving the desired level of correction and displaying the blended representation until the user is satisfied with the blended representation. In some examples, the method further includes (a) receiving an uncorrected representation of an image, (b) determining a fully corrected representation of the image based on the uncorrected representation of the image and the indication of the type of color-vision deficiency, and (c) producing a blended representation of the image based on the uncorrected representation, the fully corrected representation, and the desired level of correction.

In some examples, (a) receiving the uncorrected representation of the image includes receiving the image from a camera or an image scanner and (b) the method further includes storing the blended representation of the image in a computer file. In some examples, determining the fully corrected representation includes applying a transform to the fully corrected representation and producing the blended representation includes (a) adjusting the transform based on the desired level of correction to produce an adjusted transform and (b) applying the adjusted transform to the uncorrected representation of the element.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

The present solution will be described with reference to the following drawing figures, in which like numerals represent like items throughout the figures.

FIG. 1 shows an example graphical user interface.

FIG. 2 shows an example workflow for modifying a graphical user interface.

FIG. 3 shows a flowchart for an example workflow.

FIG. 4 shows a flowchart for an example method.

FIG. 5 provides a block diagram of an example architecture for a computing device.

### DETAILED DESCRIPTION

In the various embodiments, the devices, methods and systems of the present disclosure relate to user interfaces with improved accessibility for those having a color vision deficiency (CVD). Specifically, the present disclosure relates to modifying colors of elements that are displayed on a graphical user interface and/or printed onto tangible media so that they are more easily distinguished and particularly to adjusting the level of correction to achieve readability without unnecessary overcompensation.

There are several forms of CVD, including monochromacy, dichromacy, and anomalous trichromacy. Anomalous trichromacy, a defect in one of the three cone systems, is the most common form of CVD. The defect typically applies to middle/green and long/red wavelength sensitive cones, resulting in difficulty discriminating reds, yellows, and greens. This is commonly called “redgreen” color blindness. Protanomaly refers to a defect in L-cones (resulting in reduced sensitivity to red light), deutranomaly refers to a defect in M-cones (resulting in reduced sensitivity to green light), and trichromaly, which is much less common, refers to a defect in S-cones resulting in reduced sensitivity to blue light). Trichromaly may result in trouble discerning blues and yellows and/or blues and greens. Types of CVD are summarized in Table 1, below.

TABLE 1

| CVD type | Cause | Effect |
|---|---|---|
| Monochromacy | No cones or only one | Inability to see any color |
| | cone type exist. | (see the world in grey |
| | | shades) |
| Dichromacy | One cone type is | Inability to see the color |
| | missing, three | corresponding to the missed |
| | types: | cone type. |
| | 1) Protanopia: L-cones | Inability to see Red |
| | are missing | color (Red Blind) |
| | 2) Duteranopia: M- | Inability to see Green |
| | cones are missing | color (Green Blind) |
| | 3) Tritanopia: S-cones | Inability to see Blue |
| | are missing | color (Blue Blind) |
| Anomalous | All cone types exist, | Reduction in the |
| Trichromacy | but they are not | sensitivity to a |
| | aligned, three types: | particular color |
| | 1) Protanomaly: L- | Less sensitivity to Red |
| | cones are not aligned | color (Red weak) |
| | 2) Dueteranomaly: M- | Less sensitivity to Green |
| | cones are not aligned | color (Green weak) |
| | 3) Tritanomaly: S- | Less sensitivity to Blue |
| | cones are not aligned | color (Blue weak) |

A graphical user interface (GUI) is a digital interface that displays interactive graphical components such as icons, buttons, menus, windows, and other elements, via which a user may interact and change the content of the interface, add information to be processed, and/or activate particular features of the interface. In a GUI, the visuals displayed in the user interface convey information relevant to the user, as well as actions that are available for the user to take. Beyond computers, GUIs are used in many handheld mobile devices such as MP3 players, portable media players, gaming devices, multifunction print devices and other office equipment, automated teller machines (ATM), point of sale (POS) touchscreens at restaurants, self-service checkouts in retail stores, airline self-ticket and check-in kiosks, information kiosks in public spaces such as train stations or museums, smartphones and smaller household, office and/or industrial controls.

Color management is the process of ensuring consistent and accurate colors across various devices, such as monitors, printers, and cameras. It involves the use of color profiles, which are standardized descriptions of how colors should be displayed or reproduced. For example, a monitor may display colors differently than a printer can reproduce them. Without color management, the same image may appear differently on different devices, leading to inconsistencies and inaccuracies. To achieve color management, a color profile is created for each device involved in the color workflow. This profile describes the device's color capabilities and characteristics, such as its color gamut (range of colors it can display or reproduce) and color temperature. These profiles are then used to translate colors between devices, ensuring consistent and accurate color reproduction. Translating colors between devices may include applying a transform that is based on the profiles of the devices. Parts of color management are implemented in the operating system (O/S), helper libraries, the application, and devices. The type of color profile that is typically used is called an ICC profile, named for the International Color Consortium (ICC). A cross-platform view of color management may include the use of an ICC-compatible color management system.

Modern GUIs typically use color to highlight and distinguish different parts of the interface, e.g., to provide contrast with adjacent elements. That is, the particular colors that are applied to elements may be less relevant than applying colors that can be distinguished from one another. While some colors have cultural meaning (such as green/yellow/red for showing degrees of fault), other color choices are more arbitrary. Furthermore, the choice of GUI colors does not always emphasize the needs of users having a CVD. Therefore, GUIs may include color choices that create difficulties for these types of users.

Daltonization is a color correction technique that attempts to adjust colors in such a way that there are fewer color combinations that would be confusing to a user with CVD. That is, colors and/or intensities may be modified (or even converted to grayscale values) to reduce confusion. However, it may be possible to overcorrect. That is, the correction may be more than what is required for a particular user (who may have a milder form of CVD). Furthermore, in some cases, overcorrecting can also result in loss of information.

In some examples, color management can be used to implement Daltonization. That is, special ICC profiles can include color maps that provide greater discriminability between colors to an observer having a particular CVD. For example, a user who is fully red/green deficient may may have difficulty distinguishing between red and green pixels that have the same luminance and saturation. To address such users, the luminance of red pixels may be decreased, and the luminance of green pixels may be increased (or vice versa), so that the user can more easily perceive the difference. That is, colors can be translated from a traditional color map (e.g., CIELAB) to a Daltonization color map (e.g., with luminance adjusted as described above) before being displayed to the observer having the particular CVD. In some examples, the translation is performed using a transform such as a matrix operation or a look-up table (LUT). As described in more detail below, a user who is only somewhat red/green deficient may only need some assistance to distinguish between reds and greens of a similar luminance. In these cases, the user may only require a small adjustment to the relative luminance of red and green pixels to be able to distinguish between them. Such users may benefit from a modified matrix operation or a modified LUT that is tailored to their degree of deficiency.

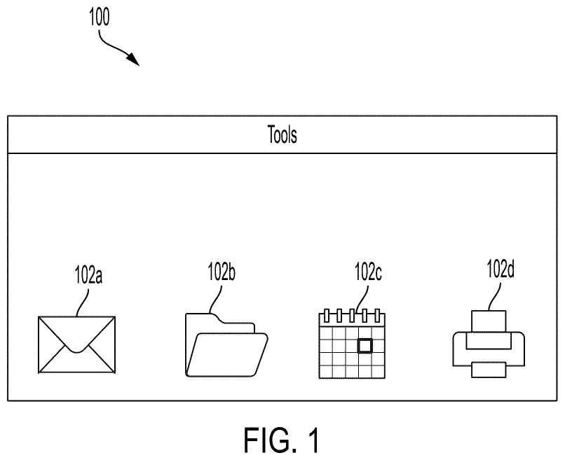

FIG. 1 shows an example GUI 100 that may be displayed to a user, e.g., on an interactive display device, such as a touchscreen display or a display that is part of a computer system having a pointing device, such as a mouse, touchpad, or trackpad. The GUI 100 includes several static and/or interactive elements, such as icons 102a-d. Each icon may indicate to the user that an action can be taken. When selected by a user, the icon 102 may cause the GUI 100 (and/or the computing device of which it is a part) to take the action. For example, icon 102a, when activated by the user, causes the computing device to launch an e-mail application. Similarly, icon 102b, when activated by the user, causes the computing device to launch a file manager application, icon 102c, when activated by the user, causes the computing device to launch a calendar application, icon 102d, when activated by the user, causes the computing device to launch a print application, etc. These icons 102 (and their associated applications) may use colors to use indicate state information and/or highlight and/or features. For example, the mail icon 102a may change colors when unread mail is available, and the calendar icon 102c may even color-code individual days on the calendar to indicate days having different types of appointments (e.g., personal vs. professional), and/or to highlight days having relatively important appointments, and/or to distinguish days that have a relatively large number of appointments (and/or large duration of appointments) from days having a relatively small number of appointments. For users having a degree of CVD, it may be difficult to distinguish between these colors. Thus, the information that the GUI intends to convey may be lost to the user.

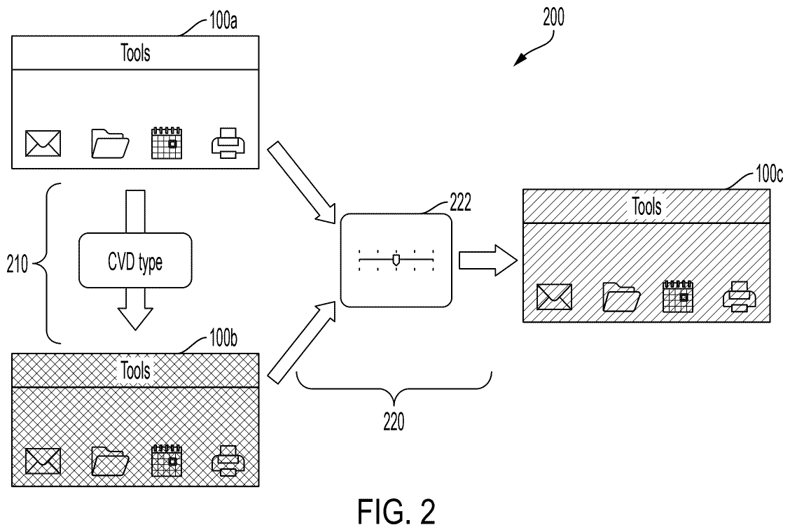

FIG. 2 shows an example workflow 200 for modifying a GUI 100, e.g., to enhance the utility of the GUI 100 for users having a CVD. The workflow starts with unmodified GUI 100a. That is, icons 102 of GUI 100a may include colors assigned by the typical color management process for the GUI 100. These colors, however, may present challenges to certain users depending on their type and degree of CVD. To address this, the icons 102 of GUI 100a are transformed through Daltonization 210 into the Daltonized icons 102 of GUI 100b. That is, less perceivable colors of the icons 102 are modified so that they are more perceivable to a user having a particular type of CVD. Daltonization 210 may be applied to individual icons (and/or other elements of GUI 100a) or may be applied to GUI 100a as a whole. As shown, Daltonization 210 is based on the particular type of CVD. A user may select a particular type of CVD, e.g., from a menu of known CVDs, to specify the Daltonization process 210, e.g., for the GUI 100 to apply. The menu may be part of an accessibility framework for the GUI 100 and may be provided as an element of an accessibility widget/dialog of the GUI 100. Example CVDs are listed in Table 1. For example, the type of CVD may be Dueteranomaly, i.e., reduced sensitivity to light wavelengths in the middle of the visible spectrum (e.g., green). In this case, the Daltonization process 210 may translate the colors of GUI 100a to other colors so that a user having reduced sensitivity to green light is more able to distinguish between the displayed colors.

In some examples, the Daltonization process 210 may be implemented within a color management framework. For example, uncorrected GUI 100a may have an associated ICC profile with a standard associated color map. That is, the color map associated with GUI 100a may be configured for perception by users having typical ability to distinguish between colors such as green and red. Fully corrected GUI 100b, on the other hand, may have an associated ICC profile with a color map that is configured for the perception of a user having a particular CVD. That is, the CVD-specific color map may deemphasize or eliminate colors that would be difficult for that user to distinguish, relying instead on available colors that are easier for the user to distinguish. For example, colors in the green range of a standard color map may be transformed into the colors in the blue range of the Dueteranomaly-specific color map. Alternatively (or in addition), the Dueteranomaly-specific color map may alter the intensity of difficult-to-distinguish colors to provide greater contrast. For example, Thus, the Daltonization process 210 includes transforming colors from a standard color map (e.g., CIELAB) to the CVD-specific color map. In some examples, transforming the colors involves the use of multi-dimensional lookup tables and/or matrix operations.

As discussed above, translating colors from a standard color map to a CVD-specific color map may modify the hue and/or luminosity/intensity of the color to make color easier to distinguish for an observer with the specific CVD. However, a color space that deemphasizes certain colors (in the interest of avoiding indistinguishable colors) puts more of a demand on the remaining portions of the color space (where colors may be more distinguishable). That is, the distinguishable portion of a CVD-specific color map will be smaller than a standard color map and thus include fewer unique colors and intensities to choose from. In some cases, the Daltonization process itself may cause undesired results. For example, translating colors from green portions of a standard color map to blue portions of a CVD-specific color map may result in the GUI 100 using a large number of different bluish colors, which may be closely spaced in the color map. Therefore, these translated colors may also be difficult to distinguish. This may result in the loss of information and/or difficulty distinguishing between elements of the GUI 100. For a user that has some degree of color acuity, a reduced correction may strike a better balance-applying sufficient correction to enable the user to distinguish between colors, without introducing undesired artifacts, such as colors that are unduly close in the color space.

To address this, the workflow 200 includes a blending step 220. The blending step 220 merges aspects of the pre-correction GUI 100a and the Daltonized GUI 100b to produce final GUI 100c. In some examples, the blending step includes calculating a weighted average of corresponding pixels from GUI 100a and GUI 100b. Thus, final GUI 100c may have a smaller degree of CVD correction than fully corrected GUI 100b. For example, in the case of a user with a full red/green deficiency, the correction may adjust the relative lightness of red and green pixels to make them more distinguishable. In an 8-bit RGB color model, a pixel with a red channel having a value of 250 and green and blue channels having values of 0 (i.e., red=250, blue=0, green=0), may be transformed to a more neutral color having a relatively low brightness (e.g., red=50 blue=50, green=50). Thus, for this particular color, the full transformation includes a reduction of the red channel by 200, and an increase of the green and blue channels by 50 each. In this case, the blended transformation may include a decreased transformation of each color channel. For example, for a 50% blend applied uniformly to all color channels, the blended pixel color may simply be the arithmetic mean of each uncorrected and uncorrected color channel. In this case, the red channel would have a value of 150 (the mean of 250 and 50), and the blue and green channels would each have a value of 25 (the mean of 0 and 50). The resulting pixel (red=150, blue=25, green=25) includes some reddish color (compared to the fully corrected pixel) and also includes some decrease in brightness. That is, final GUI 100c may have a degree of correction that is between that of uncorrected GUI 100a and fully corrected GUI 100b. This blend may strike an appropriate balance for a user that has some ability to distinguish red and green, but who also may benefit from the decreased brightness to help distinguish between these colors. It should be appreciated that this transformation is not limited to 8-bit RGB color space. A similar process may be applied to an L*a*b* color space. Furthermore, the weighted average may not be uniform. In some examples, a greater weight may be applied to, e.g., the lightness value (L*) of the L*a*b* color space.

The blending step may also receive input from the user indicating a desired degree of blending. For example, an accessibility widget of the GUI 100 may include a slider 222 or similar GUI element that allows the user to provide a value between 0 and 100%. In some examples, the user-provided degree of blending may be weighted differently for each color channel. That is, the user-provided degree of blending may first be multiplied by a channel-specific weight to produce a channel-specific amount of correction. The weight may be between 0 and 1 for each channel, which may result in a range of correction that is less than 100% in some channels. The full amount of correction for each channel may then be reduced by the channel-specific amount. For each color channel, therefore, the blended correction is the fully corrected value minus the product of (a) the total correction for the channel, (b) the desired degree of correction received from the user, and (c) a channel-specific weight. In other examples, e.g., where a matrix or a lookup table is used to translate colors from GUI 100a to GUI 100b, the user-provided degree of blending (and any channel-specific weights) may be used to modify values in the matrix or lookup table to produce a blending lookup table. Thus, the degree of blending is represented in the modified values of the matrix or lookup table. The blending lookup table can then be used to produce final GUI 100c directly from pre-correction GUI 100a. For a GUI 100 having a limited number of colors and pixels, it may be reasonably efficient to perform these calculations in real time. However, for an image with a large number of pixels (e.g., many millions of pixels), it may be more efficient to pre-calculate one or more lookup tables. To conserve memory, the lookup table(s) may include gaps between entries that require some degree of interpolation.

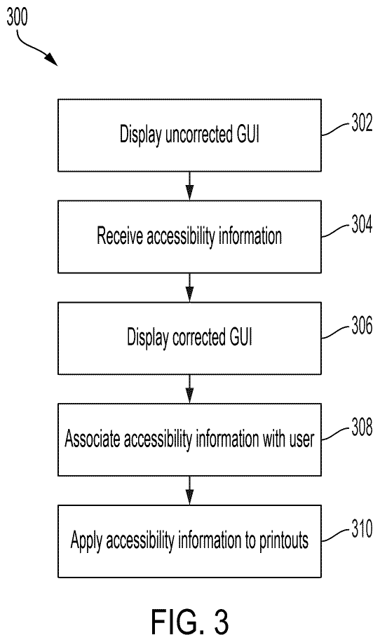

As discussed above, the GUI 100 may be implemented according to an accessibility framework. An accessibility framework provides a structured approach to ensuring that digital platforms, websites, and applications are usable by people with disabilities, promoting inclusivity and a better user experience for all users. In particular, an accessibility framework may include tools that cause the GUI 100 (and/or the computing device) to ensure that aspects of the GUI 100 are accessible to particular users. As part of the accessibility framework, the GUI 100 may include tools and techniques for adjusting aspects of the GUI 100 according to a user's CVD. For example, the GUI 100 may include an accessibility widget through which a user may adjust aspects of the GUI 100. In some examples, the widget includes a menu (e.g., for receiving a user-selected CVD type) and a slider (e.g., for receiving a user-specified degree of blending). In this case, the workflow of FIG. 2 may be implemented by the process illustrated in the flowchart 300 of FIG. 3. At step 302, the process includes displaying one or more uncorrected elements (e.g., icons 102) on a GUI 100, such as GUI 100 of FIG. 1.

At step 304, the process includes receiving accessibility information. For example, the GUI (and/or the computing device) may include an accessibility framework. The GUI may receive accessibility information via an accessibility widget or other GUI element. The accessibility information may include a type of CVD to correct for. For example, the user may have taken a color vision test, such as the Ishihara test, to determine a type of CVD. In some examples, the accessibility widget includes a menu or other multiple-choice input element, such as radio buttons or the like, which lists a selection of supported CVDs (such as those listed in Table 1). The accessibility information may also include a degree of correction to apply. The accessibility widget may include an additional element for receiving the degree of correction to apply. This additional element may be a text field, configured to receive a number (e.g., between 0 and 100%), or may be a multi-selection element configured to receive a selection from a list of discrete values between 0 and 100%. In some examples, the additional element is a slider (or similar element) that allows the user to interactively adjust the degree of correction by moving a control point along a path on the slider.

At step 306, the process includes displaying a corrected GUI. That is, the accessibility framework may process the received accessibility information to translate the colors of the GUI to be more distinguishable to an observer with the selected CVD. In some examples, the degree of correction is initially set to 0%. In that case, the user must first enter a non-zero degree of correction before a corrected GUI is displayed. In the example of a slider, the user would move the control point from the initial value to a non-zero value. In other examples, the degree of correction is initially set to a non-zero value, such as 50% or 100%. Therefore, the corrected GUI (either fully or partially corrected) can be displayed immediately upon user-selection of a CVD. That is, the colors of the GUI may be translated to a partially or fully corrected values for the user to assess. The user may adjust the degree of correction, e.g., using the accessibility widget, as the GUI applies the degree of correction in real time. By iteratively adjusting the degree of correction, the user can view and assess the blended representation at each level of correction until the user is satisfied with the result. Through this process, the user may determine an appropriate level of correction. For example, the user may select the least degree of correction that allows the user to effectively distinguish colors.

At step 308, the process includes associating accessibility information with the user. For example, the accessibility framework may include an accessibility profile for each user. The accessibility profile may include the type of CVD and the desired degree of correction received from the user (e.g., using the accessibility widget). The GUI may associate the user's accessibility profile with the user's login account so that each time the user logs in, the GUI automatically applies the user's accessibility profile to subsequent GUI elements. Thus, the GUI will automatically display appropriately CVD-corrected GUI elements to the user each time the user logs in, without requiring the user to provide accessibility information each time. Furthermore, as discussed above, the GUI may apply corrections to individual GUI elements (e.g., icons 102 or windows) or the GUI may apply corrections to the entire GUI. This feature may save the user the effort of reconfiguring the GUI for each session.

At step 310, the GUI 100 may apply the same accessibility information to materials that are printed out using the GUI 100. In some examples, the GUI 100 includes a print management system that controls aspects of printing performed through the GUI 100. The print management system may translate colors of printable images (e.g., from a camera, flatbed scanner, or other source) to more distinguishable colors based on the type of CVD and the degree of correction received from the user. The print management system may perform translation of colors for printed materials in a similar fashion to displayed elements of the GUI 100 described above. Thus, the system may reuse the configuration performed for displaying GUI elements, without requiring the user to perform a separate configuration specifically for printed material. However, in other embodiments, the system may maintain separate configurations for display and printed elements.

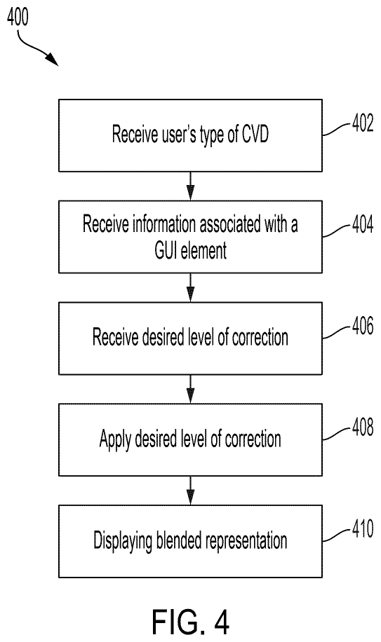

FIG. 4 shows a flowchart 400 of a method of displaying elements on a graphical user interface. At step 402, the method includes receiving an indication of a type of CVD of a user. As described above, this step may include receiving user input via an accessibility widget, and the type of CVD may be one of the types listed in Table 1. At step 404, the method includes receiving information associated with an element to display on a GUI. In some examples, the element to display is an icon 102 or other display elements of the GUI. In some examples, the element is the entire GUI. At step 406, the method includes receiving a desired level of correction from the user. As described above, the level of correction may also be received via an accessibility widget.

At step 408, the method includes applying the desired level of correction to the element to display. Applying the desired level of correction may include: (i) determining an uncorrected representation of the element based on the information associated with the element to display, (ii) determining a fully corrected representation of the element based on the information associated with the element to display and the indication of the type of color-vision deficiency, and (iii) producing a blended representation based on the uncorrected representation, the fully corrected representation, and the desired level of correction. In some examples, determining the uncorrected representation of the element may include rendering the element on a display in its uncorrected form. That is, the representation of the element is the rendered element. Alternatively, determining the uncorrected representation may be performed in computer memory without actually displaying the element. In the latter case, the representation is a representation in computer memory, rather than on the display screen. Similarly, determining the fully corrected representation (i.e., after Daltonization) may include rendering the fully corrected element or may include determining the fully corrected representation in computer memory without an intermediate step of displaying the element. Similarly, producing the blended representation may include determining the blended representation (e.g., weighted average of the original and the Daltonized representations) in computer memory rather than on a display screen. At step 410, the method includes displaying the blended representation on the graphical user interface.

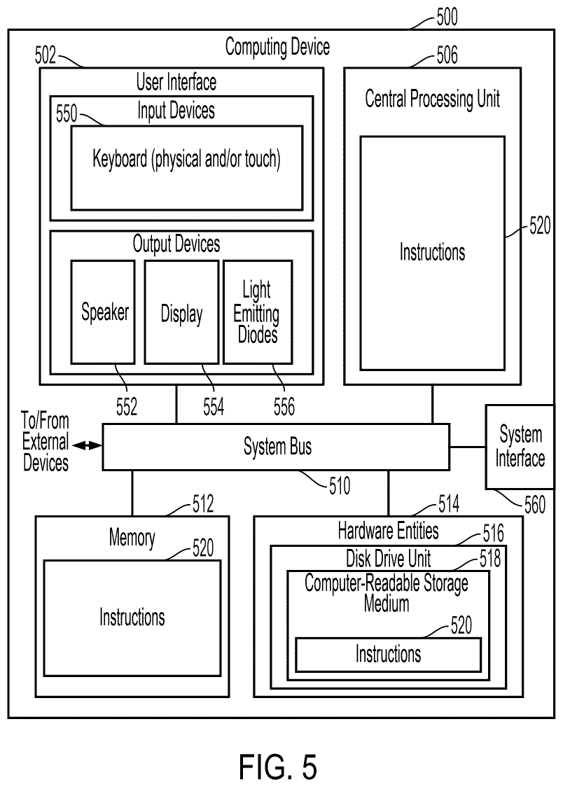

As shown in FIG. 5, the computing device 500 includes a user interface 502, a Central Processing Unit (CPU) 506, a system bus 510, a memory 512 connected to and accessible by other portions of computing device 500 through system bus 510, a system interface 560, and hardware entities 514 connected to system bus 510. The user interface can include input devices and output devices, which facilitate user-software interactions for controlling operations of the computing device 500. The input devices include, but are not limited to, a physical and/or touch keyboard 550. The input devices can be connected to the computing device 500 via a wired or wireless connection (e.g., a Bluetooth® connection). The output devices include, but are not limited to, a speaker 552, a display 554, and/or light emitting diodes 556. System interface 560 is configured to facilitate wired or wireless communications to and from external devices (e.g., network nodes such as access points, etc.).

At least some of the hardware entities 514 perform actions involving access to and use of memory 512, which can be a Random Access Memory (RAM), a disk drive, flash memory, a Compact Disc Read Only Memory (CD-ROM) and/or another hardware device that is capable of storing instructions and data. Hardware entities 514 can include a disk drive unit 516 comprising a computer-readable storage medium 518 on which is stored one or more sets of instructions 520 (e.g., software code) configured to implement one or more of the methodologies, procedures, or functions described herein. The instructions 520 can also reside, completely or at least partially, within the memory 512 and/or within the CPU 506 during execution thereof by the computing device 500. The memory 512 and the CPU 506 also can constitute machine-readable media. The term “machine-readable media”, as used here, refers to a single medium or multiple media (e.g., a centralized or distributed database, and/or associated caches and servers) that store the one or more sets of instructions 520. The term “machine-readable media”, as used here, also refers to any medium that is capable of storing, encoding or carrying a set of instructions 520 for execution by the computing device 500 and that cause the computing device 500 to perform any one or more of the methodologies of the present disclosure.

The following paragraphs provide additional information about various terms used in this document:

In this document, the term “approximately,” when used in connection with a numeric value, is intended to include values that are close to, but not exactly, the number. For example, in various embodiments, the term “approximately” may include values that are within +/−1 percent of the value, +/−5 percent of the value, +/−10 percent of the value, or any value or fraction thereof between any or all of the values.

The term “substantially,” when used in connection with a value, is intended to mean approximately, within a threshold tolerance that is a percentage corresponding to any of the percentages described in the previous paragraph. For example, items described as “substantially the same,” “substantially equal,” or “substantially planar,” may be exactly the same, equal, or planar, or may be the same, equal, or planar within acceptable variations that may occur, for example, due to manufacturing processes and/or tolerances.

As used in this document, the singular form “a”, “an”, and “the” include plural references unless the context clearly dictates otherwise. Unless defined otherwise, all technical and scientific terms used herein have the same meaning as commonly understood by one of ordinary skill in the art. As used in this document, the term “comprising” means “including, but not limited to.”

The terms “printer” and “print device” refer to a machine having hardware capable of reading digital data and using the information from the data and associated print instructions to print a physical document on a substrate. In some embodiments, a print device may have additional capabilities such as scanning or faxing and thus may be a multifunction device. Example print devices include traditional printers and multifunction devices, as well as specialized print devices such as ticket printers, sales receipt printers, and the like. Components of a print device typically include a print engine, as well as a document feeding system configured to pass a substrate through the print device so that the printhead or printheads of the print engine can print characters and/or images on the substrate.

The term “processor” refers to electronic device hardware that is configured to execute programming instructions. The term “processor” may refer to either a single processor or to multiple processors that together implement various steps of a process. Unless the context specifically states that a single processor is required or that multiple processors are required, the term “processor” includes both the singular and plural embodiments.

The terms “memory,” “memory device,” “computer-readable medium” and “data store” each refer to a non-transitory device on which computer-readable data, programming instructions or both are stored. Unless the context specifically states that a single device is required or that multiple devices are required, the terms “memory,” “memory device” “computer-readable medium” and “data store” include both the singular and plural embodiments, as well as portions of such devices such as memory sectors.

This disclosure is not limited to the particular systems, methodologies or protocols described, as these may vary. The terminology used in this description is for the purpose of describing the particular versions or embodiments only and is not intended to limit the scope.

It will be understood that various modifications may be made to the embodiments disclosed in this document. Likewise, the above disclosed methods may be performed according to an alternate sequence. Therefore, the above description should not be construed as limiting, but merely as examples of the various embodiments. Those skilled in the art will envision other modifications within the scope and spirit of the claims appended to this document.

The described features, advantages, and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such a feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

What is claimed is:

1. A computer device comprising:
a display;
a processor;
a computer readable memory;
a computer readable storage medium, and
program instructions stored on the computer readable storage medium for execution by the processor the program instructions configured to cause the computer device to:
receive an indication of a type of color-vision deficiency of a user;
receive information associated with an element to display on a graphical user interface;
receive a desired level of correction from the user;
apply the desired level of correction to the element to display by:
determining an uncorrected representation of the element based on the information associated with the element to display;
determining a fully corrected representation of the element based on the information associated with the element to display and the indication of the type of color-vision deficiency; and
producing a blended representation based on the uncorrected representation, the fully corrected representation, and the desired level of correction; and
display the blended representation on the graphical user interface.

2. The computer device of claim 1, wherein the program instructions that are configured to cause the computer device to apply the desired level of correction by producing a blended representation comprise program instructions that are configured to cause the computer device to apply the desired level of correction by performing a weighted average of one or more values associated with pixels of the uncorrected representation and corresponding values associated with pixels of the fully corrected representation, based on the desired level of correction, to produce pixels of the blended representation.

3. The computer device of claim 1, wherein the program instructions that are configured to cause the computer device to display the blended representation comprise program instructions that are configured to cause the computer device to display pixels of the blended representation.

4. The computer device of claim 1, wherein:
the program instructions that are configured to cause the computer device to receive information associated with the element to display comprise program instructions that are configured to cause the computer device to receive information associated with an icon to display on the graphical user interface; and
the program instructions that are configured to cause the computer device to display the blended representation comprise program instructions that are configured to cause the computer device to display a blended representation of the icon on the graphical user interface.

5. The computer device of claim 1, wherein:
the program instructions that are configured to cause the computer device to receive information associated with the element to display comprise program instructions that are configured to cause the computer device to receive information associated with a window to display on the graphical user interface; and
the program instructions that are configured to cause the computer device to display the blended representation comprise program instructions that are configured to cause the computer device to display a blended representation of the window on the graphical user interface.

6. The computer device of claim 1, wherein the program instructions are further configured to cause the computer device to:
associate the indication of the type of color-vision deficiency and the desired level of correction with an account associated with the user; and
automatically apply the desired level of correction to subsequent elements to display.

7. The computer device of claim 1, wherein the program instructions that are configured to cause the computer device to receive the desired level of correction from the user comprise program instructions that are configured to iteratively receive the desired level of correction and display the blended representation until the user is satisfied with the blended representation.

8. The computer device of claim 1, wherein the program instructions are further configured to cause the computer device to:
receive an uncorrected representation of an image;
determine a fully corrected representation of the image based on the uncorrected representation of the image and the indication of the type of color-vision deficiency; and
produce a blended representation of the image based on the uncorrected representation, the fully corrected representation, and the desired level of correction.

9. The computer device of claim 8, wherein:
the program instructions that are configured to cause the computer device to receive the uncorrected representation of the image comprise program instructions that are configured to cause the computer device to receive the image from a camera or an image scanner; and
the program instructions are further configured to cause the computer device to store the blended representation of the image in a computer file.

10. The computer device of claim 1, wherein:
the program instructions that are configured to cause the computer device to determine the fully corrected representation comprise program instructions that are configured to cause the computer device to apply a transform to the fully corrected representation; and
the program instructions that are configured to cause the computer device to apply the desired level of correction by producing a blended representation comprise program instructions that are configured to cause the computer device to apply the desired level of correction by:
adjusting the transform based on the desired level of correction to produce an adjusted transform; and
applying the adjusted transform to the uncorrected representation of the element.

11. A method of displaying elements on a graphical user interface, the method comprising, by a processor:
receiving an indication of a type of color-vision deficiency of a user;
receiving information associated with an element to display on a graphical user interface;
receiving a desired level of correction from the user;
applying the desired level of correction to the element to display by:
determining an uncorrected representation of the element based on the information associated with the element to display;
determining a fully corrected representation of the element based on the information associated with the element to display and the indication of the type of color-vision deficiency; and
producing a blended representation based on the uncorrected representation, the fully corrected representation, and the desired level of correction; and
displaying the blended representation on the graphical user interface.

12. The method of claim 11, wherein producing the blended representation comprises performing a weighted average of one or more values associated with pixels of the uncorrected representation and corresponding values associated with pixels of the fully corrected representation, based on the desired level of correction, to produce pixels of the blended representation.

13. The method of claim 12, wherein displaying the blended representation comprises displaying pixels of the blended representation.

14. The method of claim 11, wherein:
receiving information associated with the element to display comprises receiving information associated with an icon to display on the graphical user interface; and
displaying the blended representation comprises displaying a blended representation of the icon on the graphical user interface.

15. The method of claim 11, wherein:
receiving information associated with the element to display comprises receiving information associated with a window to display on the graphical user interface; and
displaying the blended representation comprises displaying a blended representation of the window on the graphical user interface.

16. The method of claim 11, further comprising:
associating the indication of the type of color-vision deficiency and the desired level of correction with an account associated with the user; and
automatically applying the desired level of correction to subsequent elements to display.

17. The method of claim 11, wherein receiving the desired level of correction from the user comprises iteratively receiving the desired level of correction and displaying the blended representation until the user is satisfied with the blended representation.

18. The method of claim 11, further comprising:
receiving an uncorrected representation of an image;
determining a fully corrected representation of the image based on the uncorrected representation of the image and the indication of the type of color-vision deficiency; and
producing a blended representation of the image based on the uncorrected representation, the fully corrected representation, and the desired level of correction.

19. The method of claim 18, wherein:
receiving the uncorrected representation of the image comprises receiving the image from a camera or an image scanner; and
the method further comprises storing the blended representation of the image in a computer file.

20. The method of claim 11, wherein:
determining the fully corrected representation comprises applying a transform to the fully corrected representation; and
producing the blended representation comprises:
adjusting the transform based on the desired level of correction to produce an adjusted transform; and
applying the adjusted transform to the uncorrected representation of the element.
